(19) United States
(12) Patent Application Publication
(10) Pub. No.: US 2001/0004858 A1
(43) Pub. Date: Jun. 28, 2001

(54) FASTENER EXTRACTOR

(76) Inventor: ROBERT E. KACHERGIUS, ORLAND PARK, IL (US)

Correspondence Address: SIMON B. ANOLICK, GARDNER CARTON & DOUGLAS, 321 NORTH CLARK SUITE 3400, CHICAGO, IL, 60610

(21) Appl. No.: 09/291,690

(22) Filed: Apr. 13, 1999

(51) Int. Cl. B25B 7/02

(52) U.S. Cl. 81/424.5

(57) ABSTRACT

A fastener removing tool in accordance with the invention utilizes a design having a handle portion and a head portion with a bend between the handle portion and the head portion, wherein the head portion has two gripping members that may be opened and closed, and wherein each gripping member further comprises a groove having a pair of opposing gripping edges each of which defines an angle of approximately 90° and where the grooves may be opposing when the halves of the head are in a closed position, and wherein the head portion further comprises a top and an opposing protrusion into which protrusion the grooves extend.

### BACKGROUND OF THE INVENTION

1. Field of the Invention

The invention relates generally to hand tools, and more particularly to a hand tool for removing threaded fasteners having a head.

2. Description of the Prior Art

Quite commonly, threaded fasteners such as screws become difficult to remove, or “frozen,” after insertion. Often, and particularly the case with Phillips head fasteners, the screwdriver slots on the head become stripped when removal is attempted so that it is difficult or impossible to remove the fastener using conventional means such as a screwdriver. One other reason fasteners may be difficult to remove is that they are sealed into place with paint or glue. Yet another reason is that the threads may be corroded (particularly when inserted into metal), causing the threads to become frozen in the bore into which the fastener is inserted.

Such frozen screws can sometimes be removed by pry-type instruments, such as hammer claws or pry bars, or the screw head can be clipped or chiseled off, or drilled out of the material. At that point, the material must then be prepared to accept a different fastener, which is generally done by oversize drilling and re-tapping, or by resizing the original threaded bore such as by using a “Heli-Coil (™) type threaded insert.

However, it is most desirable to completely remove the fastener without damaging the threaded bore in the material, and in some cases without damaging the fastener itself. This is particularly important when the fastener is unique or when it is undesirable to create a second opening for a new fastener, such as when building or repairing furniture and the like. In such cases, the frozen fastener must be turned out without the use of vertical force so that the threads on both the fastener and in the material remain intact.

Pliers (either needle-nosed or ordinary) can sometimes be used to grasp and turn the head of the fastener, but this method of removal is very difficult if the fastener is firmly frozen in place, since the pliers tend to slip off the head of the screw when force is applied.

Other prior art fastening remover devices, such as those illustrated in U.S. Pat. Nos. 2,043,373 and 4,084,457, utilize a combination of both vertical and rotational forces to effect removal of the frozen fastener. Such fastener removing devices suffer from the drawback of shearing the fastener from its position during application of the vertical forces, thereby damaging the threads on the fastener and the thread imprint on the material, rendering both the fastener and its opening in the material unusable.

One additional drawback of some prior art devices which use rotational force to remove fasteners is that the means of gripping the fastener may weaken and break with repeated usage.

Thus, it is an object of the invention to provide a tool for removing threaded fasteners which does not damage the threads on the fasteners or the threads in the fastener bore.

It is yet another object of the invention to provide a tool for removing threaded fasteners which utilizes only rotational forces for removal.

It is also an object of the invention to provide a tool for removing fasteners having gripping edges which may be sharpened.

Yet another object of the invention is to provide a tool for removing threaded fasteners which utilizes a gripping mechanism with improved durability as compared to prior art devices.

An additional object of the invention is to provide a tool for removing fasteners whereby the tool may be gripped with either one or two hands while applying an evenly distributed rotational force to the circumference of the fastener.

A more particular object is to provide a tool for removing threaded fasteners of differing head sizes and shapes.

Other objects will become apparent from the following summary and description of its preferred embodiments.

### SUMMARY OF THE INVENTION

A fastener removing tool in accordance with the invention utilizes a design having a handle portion and a head portion, wherein the head portion has two gripping members that may be opened and closed, and wherein each gripping member further comprises a groove having a pair of opposing gripping edges each of which defines an angle of approximately 90° and where the grooves may be opposing when the gripping members are in a closed position, and wherein the head portion further comprises a top and an opposing protrusion into which protrusion the grooves extend. The gripping members are squeezed about the perimeter of the head of the fastener and the gripping edges of each member are oppositely opposed such that the fastener to be removed is gripped between the edges and may be readily rotated and removed without the use of vertical forces. The handle of the invention is angled with respect to the gripping end to provide a an evenly firm grasp of the fastener on the gripping end, with sufficient clearance between the material surface and the handle for a fist to firmly grasp the handle. This angle allows gripping edges to firmly and evenly grasp the outer circumference of the protruding fastener head, which evenly distributes the gripping forces around the fastener head and minimizes slipping of the gripping edges from the fastener. This design maximizes the user's ability to apply rotational torque to the head of the frozen fastener by applying a closing pressure on the handles (with sufficient clearance of the material surface to use either one or possibly both hands to grip the fastener if necessary) thus allowing the fastener to be turned out without vertical force and without damage to the screw threads or the threaded bore the fastener is inserted into.

Further features, objects and advantages of the invention will be apparent from the drawings and description set forth below.

### BRIEF DESCRIPTION OF THE DRAWINGS

FIG. 1 is a schematic diagram of a fastener remover made in accordance with the principles of the invention.

FIG. 2 is a side perspective drawing of a fastener remover of the invention.

FIG. 3 is a side view of a tool of the invention gripping a fastener.

FIG. 4 is a top-view of a tool of the invention gripping a fastener.

FIG. 5 is expanded view of the gripping end of a tool made in accordance with the principles of the invention illustrating the gripping edges.

### DESCRIPTION OF THE PREFERRED EMBODIMENTS

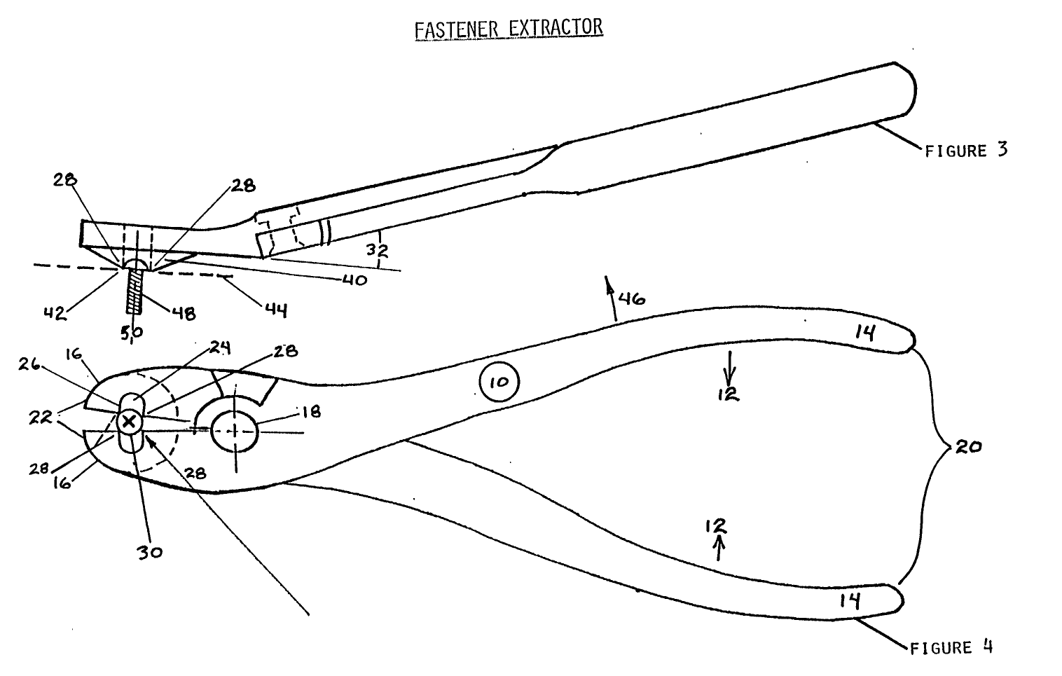

A tool made in accordance with the invention is shown generally in FIG. 1 at 10 and includes two members 12, each member having a handle end 14 and a gripping end 16. In this preferred embodiment, the two members are pivotally joined about a rotational axis 18 similar to that seen in pliers, although the joining may be accomplished by any of a number of suitable means which are known to those skilled in tool arts. The joining must only be of a type that allows the two gripping ends 16 to be brought together while holding the handle 20, which is a double-handled pliers-type device. Once joined, the tool 10 has a handle portion having two handles 14, and a head portion having and two heads, 22. Each head has a gripping end 16, which includes a u-shaped groove 24 (although differently shaped grooves may be used), which groove 24 partly defines the inner wall 26 of each of 2 opposing 90° gripping edges 28, which edges grasp the circumference of a fastener head 30, as illustrated in FIGS. 3 and 4.

The tool 10 is designed with an angular handle bend 32 of approximately 15° to 25° in this embodiment (although any other angle that will provide clearance for a gripping hand will work), providing room for a comfortable grip position for the operator, in contrast to prior art tools which are designed to be held vertically (and thus have little leverage with which to rotate the handle), or which cause the grip on the fastener to be uneven as a result of angling the tool sufficient to grasp and rotate it (such as with ordinary pliers).

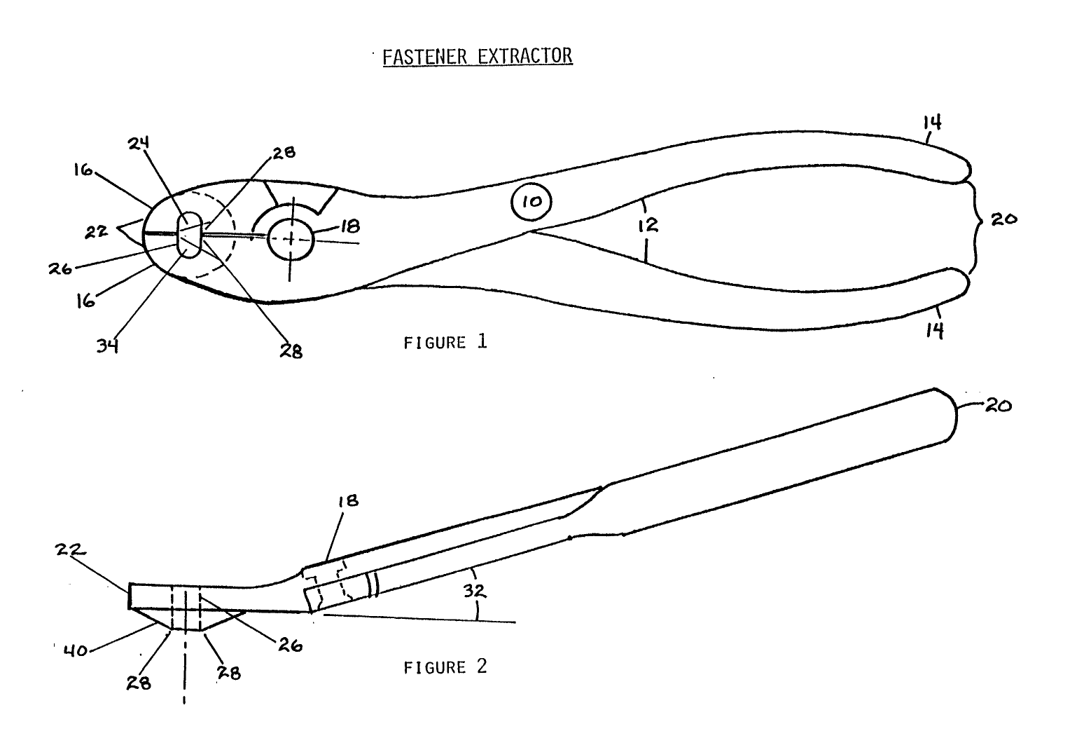

When handle halves 14 are pressed together, the u-shaped grooves 24 in each gripping end 16 define a generally oblong opening 34 in the head 22 of the tool 10. The grooves 24 are machined so that the sides 26 of the grooves are generally perpendicular to the horizontal plane of the head 22, as illustrated in FIG. 2. When closed, the gripping edges 28 of each gripping end 16 are adjacent, as illustrated in FIG. 1. During use, the gripping edges 28 are used to grasp the head 30 of the frozen fastener, and to provide a balanced source for rotational torque on approximately opposite sides of the fastener head 30.

One significant advantage of a tool of the invention over the prior art is that the tool head 22 is equipped with a gripping protrusion 40, which protrusion may be attached, or it may be machined as part of head 22. As illustrated in FIGS. 1-3, when the tool is in the “closed” position, the protrusion 40 is frusto-conical in shape and the gripping surface 42 of the protrusion 40 is flat, although any other shape protrusion and gripping surface may be utilized, as long as the diameter of the gripping surface is less than the diameter of the top of the head when the tool is in the “closed” position. The protrusion assists in raising the tool head 22 off of the material surface 44 to which the fastener 48 is attached (as illustrated in FIG. 3). The protrusion 40 provides clearance for the tool head 22 to be manipulated with minimal scarring or rotational marking or other incurred damage to the material surface 44 during use of the invention in removing fasteners 48, as illustrated in FIG. 3.

A second significant advantage of the invention is that each of the four 90° gripping edges 28 grasp only the outer perimeter of the fastener head 30; the edges 28 do not come in contact with any surrounding or adjacent surfaces of the parent material 44.

To position the tool 10 on a frozen fastener head 30, the handle ends 14 of the handle 20 are separated, thus separating the gripping ends 16, which should be separated by a distance wider than the size of the fastener head 30 to be removed.

The gripping edges 28 should then be positioned around the perimeter of fastener head 30. Then, inward hand pressure 12 is applied to the handle ends 14 until the gripping edges 28 are at least partially penetrating into the fastener head 30, as illustrated in FIG. 4, and the gripping pressure is maintained throughout use of the tool 10. Next, rotational unscrewing torque is applied (generally in the direction illustrated by arrow 46) to handle 20, thus freeing the fastener 48 to rotate sufficient to remove fastener 48 from the material 44. Because of the protrusion 40 and the head/handle angular bend 32, slippage of the 90° gripping edges 28 from the fastener head 30 is minimized as compared to prior art designs with less than 45° gripping edges and protrusions. Once the fastener 48 is initially loosened, the fastener may be removed by any suitable means.

As is apparent from FIGS. 2 and 3, the lateral spacing of the opposing 90° gripping edges 28 must be less than the diameter of the fastener head 30. Any size spacing is suitable, although it is contemplated that the tool may be manufactured with at least two different dimensional openings—one to accommodate small fastener heads such as, for instance, those fasteners with heads having a diameter of less than ⅜ inch, and one to accommodate larger fastener heads, for instance those fasteners having heads of a diameter of more than ⅜ inch.

The tool of the invention offers the distinct advantage of providing a positive gripping action in a single horizontal plane, perpendicular to the vertical center line 50 of the fastener 48. This arrangement maximizes even and constant application for rotational torque to the fastener, minimizing the possibility that the fastener head 30 will be sheared off from the fastener shaft 48. Moreover, with this design, no application of vertical force is necessary, and thread preservation is maximized.

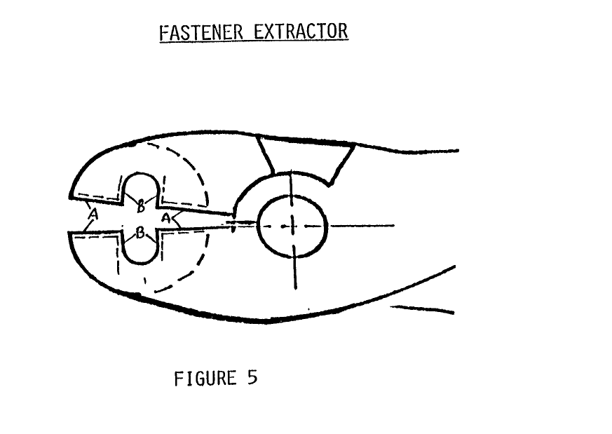

The four gripping edges 28 comprise an angle of approximately 90°, providing the edges with maximum strength and gripping action compared to edges of less than 90°. Moreover, if the gripping edges 28 become dull or worn, they are easily resharpened by grinding or filing a small amount of material from each side of the edge, illustrated as edge “A”” or edge “B” of FIG. 5.

While the preferred embodiment of the invention described above has a pivoting connector in the fashion of common pliers, any connector that provides for tightening the grip halves together while squeezing the handles will be useful in the invention. One alternative connection means is that employed by a vise-type grip.

The utility and advantages afforded by the subject invention will readily apparent from the specification and the drawings. It should be understood that although specific embodiments are described herein, such embodiments are illustrative and not restrictive, and all variations thereon so not depart from the spirit and scope of the claims.

What is claimed is:

1. A hand tool for removing threaded fasteners, comprising:
a handle portion and a head portion, wherein the head portion has two gripping members that may be opened and closed, and wherein each gripping member further comprises a groove having a pair of opposing gripping edges each of which defines an angle of approximately 90° and where the grooves may be opposing when the halves of the head are in a closed position, and wherein the head portion further comprises a top and an opposing protrusion having a gripping surface into which protrusion the grooves extend; and
a bend between the handle portion and the head portion.

2. The tool of claim 1 wherein the angle of the bend ranges in size from about 12° to about 30°.

3. The tool of claim 1 wherein each gripping edge is substantially perpendicular to the gripping surface of the protrusion.

4. The tool of claim 1, wherein the tool is comprised of two halves connected by an intermediate fulcrum located between the handle portion and the head portion.

5. The tool of claim 1 wherein the head portion is formed integrally with the handle portion.

6. The tool of claim 1 wherein the handle portion has two handles.

7. The tool of claim 1 wherein the gripping edges may be sharpened.

8. The protrusion of claim 1 wherein the diameter of the gripping surface is smaller than the diameter of the top of the head portion of the tool.

9. The tool of claim 8 wherein the gripping surface is flat.

10. A hand tool for removing threaded fasteners comprising:
a handle portion having first and second handles; and
a gripping portion comprising first and second gripping heads; and
an intermediate fulcrum;
wherein the first handle is integrally connected to the first gripping head to form a first tool half and the second handle is integrally connected to the second gripping head to form a second tool half and both tool halves are pivotally connected through an intermediate fulcrum; and further wherein the gripping portion also comprises a top and an opposing protrusion having an end, wherein the diameter of the end is less than the diameter of the top; and wherein the gripping portion further comprises gripping edges.
